(19) United States
(12) Patent Application Publication
(10) Pub. No.: US 2009/0026756 A1
(43) Pub. Date: Jan. 29, 2009

(54) ELECTROFUSION FITTING FOR A COMPOSITE PIPE

(75) Inventor: Jeremy Bowman, Chesterfield (GB)

Correspondence Address: SHERIDAN ROSS PC, 1560 BROADWAY, SUITE 1200, DENVER, CO, 80202, US

(73) Assignee: UPONOR INNOVATION AB, Fristad (SE)

(21) Appl. No.: 11/912,259

(22) PCT Filed: Apr. 19, 2006
(86) PCT No.: PCT/GB2006/001423

§ 371 Date: Apr. 10, 2008

(30) Foreign Application Priority Data
Apr. 22, 2005 (GB) 0508112.0

(51) Int. Cl. F16L 47/03

(52) U.S. Cl. 285/21.2

(57) ABSTRACT

An electrofusion fitting for a composite plastics pipe, the pipe comprising at least one inner plastics layer, at least one outer plastics layer and at least one barrier layer therebetween, the fitting comprising a tubular body formed at least in part from a thermoplastic polymer material and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, such that the exposed barrier layer at the cut end of the pipe is environmentally sealed on each side by a fusion joint.

This invention relates to fittings for composite pipes, and more particularly to electrofusion fittings for composite plastic pipes having an internal barrier or strengthening layer.

### BACKGROUND

Multilayer pipes, wherein at least one of the layers comprises a barrier or strengthening layer, are well known and a great many have been described in the literature. Multilayer pipes are used, for example, when improved long term strength at elevated temperatures is needed or, when barrier properties against fluid permeation or ingress of contaminants are required. Multilayer pipes can comprise dissimilar materials for particular applications. In particular, multilayer pipes having oxygen diffusion barrier layers have been proposed. The diffusion barrier can be a polymeric layer such as EVOH, or an impermeable metallic layer which provides both a diffusion barrier and a strengthening layer.

In recent years multilayer pipes having aluminium or aluminium-based metallic barrier layers have become very popular. When installing domestic heating systems the metallic barrier provides two specific and important benefits. The first is that when the pipe is bent it retains its new configuration, in contrast to plastics pipes without a metallic barrier layer, which tend to relax after bending to recover their original shape. The second is that the metallic barrier layer acts to inhibit oxygen diffusion through the plastics pipe and thereby reduces corrosion of radiators and valves in the system.

A further benefit of plastics pipes with metallic barrier layers is that the metallic layer prevents UV light from reaching the inner plastics layer(s) beneath it, thereby protecting these layer(s) from UV degradation. This protection obviates the need for the addition of UV stabilisers to the inner layer(s) and enables the stabiliser packages of the inner and outer plastics layers to be optimised, with the inner layer(s) requiring only thermal and chemical stabilisation. Examples of plastics pipes having metallic barrier and strengthening layers and methods for their manufacture are disclosed in the following patents:

| | |
|---|---|
| CH | 655986 |
| JP | 93-293870 |
| EP | 0644031 |
| EP | 0353977 |
| EP | 0581208 |

The entire disclosures of all these documents are incorporated herein by reference for all purposes.

The use of a metallic barrier layer does, however, give rise to certain complications. For example, non-polar polymeric materials such as polyethylene do not bond to aluminium, giving rise to potential delamination issues. Thus, in manufacturing processes wherein the inner plastics layer is directly extruded into a freshly formed and welded aluminium tube comprising the barrier layer, the thermal shrinkage of the hot extruded inner plastics layer tends to cause delamination, requiring the use of a high strength adhesive between the inner plastics layer and the aluminium tube. Similarly with the outer plastics layer, the adhesion of the extruded plastics material to the surface of the aluminium usually needs to be enhanced by the provision of an intermediate adhesive layer.

When joining two or more composite plastics pipes, or when connecting a composite plastics pipe to a fitting, it is important that the exposed barrier layer and any adhesive layers at the cut end of the pipe should not be exposed to the environment. Atmospheric moisture, or fluid from the pipe, can track along the barrier layer surfaces or diffuse through the adhesive layers causing delamination and structural failure of the pipe. Hitherto this has necessitated the use of special mechanical metal fittings having protective means for the cut end of the pipe.

A popular means of joining polyolefin pipes, or of connecting a polyolefin pipe to a fitting, is electrofusion, in which adjacent polyolefin surfaces are heated and fused together using an electric resistance or induction heating element. Typically, in joining polyolefin pipes, the cut pipe ends are received within an electrofusion coupler comprising an injection moulded tubular polyolefin body having an embedded electric heating element and terminals for connection to an electric power supply. When the electric heating element is energized the outer surfaces of the pipes are fused to the inner surface of the polyolefin body. This conventional coupler has, however, no means to protect the exposed barrier layers at the cut pipe ends and thus cannot be used for composite plastics pipes.

In JP10220676 there is described an electrically fused joint for synthetic resin pipes, which is provided with a cylindrical joint body made of the same material as the pipes, and which is mounted over the abutting pipe ends. The joint body has a current carrying heater body buried therein, and the inner diameter of the joint body increases continuously from the center to the outside in the axial direction. The problem of joining composite pipes is not addressed and indeed the joint of JP10220676 could not be used with a composite pipe having a metallic barrier layer because the heater body would be “shorted out” by the metallic barrier layer.

In DE4444097 there is described a welding junction sleeve for two composite pipes. The pipes fit into sections of the welding sleeve equipped with resistance heating elements. Each section has an interior abutment surface formed on the interior of the junction sleeve. The resistance heating element of each section has a further part in the vicinity of the abutment surface. However, when the resistance heating element is energized the plastics material at the abutment surfaces will become molten and there is nothing to prevent the molten plastics material from flowing away from the pipe cut end and leaving the barrier layer exposed. Furthermore, there is a risk of the heating element shorting out against the exposed metal barrier layer.

WO98/22744 describes a pipe connector for a composite pipe comprising at least one reinforcing layer, or layer of high axial strength, the connector comprising a hollow, tubular enclosure adapted to receive a pipe, fusion means adapted to make a fusion connection with the inner thermoplastic layer of the pipe, mechanical gripping means adapted to grip the reinforcing layer or layer of high axial strength, and sealing means adapted to form an environmental seal with the outer protective layer of the pipe, the fusion means, gripping means and sealing means being disposed within the enclosure and the enclosure being adapted to apply a constraining force to the gripping means and the sealing means. This is a relatively complicated construction and does not provide a wholly fused joint.

It is apparent that there are several problems associated with the production of fusion joints for composite plastics pipes. In particular, it would be desirable to provide an improved electrofusion fitting whereby the exposed barrier layer at the cut end of the pipe is environmentally sealed.

### BRIEF SUMMARY OF THE DISCLOSURE

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

In a first aspect the present invention provides an electrofusion fitting for a composite plastics pipe, the pipe comprising at least one inner plastics layer, at least one outer plastics layer and at least one barrier layer therebetween, the fitting comprising a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, such that the exposed barrier layer at the cut end of the pipe is environmentally sealed on each side by a fusion joint.

In a second aspect the invention provides a method of forming a joint for a composite pipe, the pipe comprising at least one inner plastics layer, at least one outer plastics layer and at least one barrier layer therebetween, wherein there is used an electrofusion fitting, the fitting comprising a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, inserting the cut pipe end into the tubular body and energizing the electric heating elements to fuse the first and second sections respectively to the inner and outer plastics layers such that the exposed barrier layer at the cut end of the pipe is environmentally sealed on each side by a fusion joint.

In a third aspect the invention provides a joint for a composite pipe formed using an electrofusion fitting or method according to the first and second aspects of the invention.

In a fourth aspect the invention provides the use of an electrofusion fitting to form a joint in a composite pipe, the pipe comprising at least one inner plastics layer, at least one outer plastics layer and at least one barrier layer therebetween, wherein the fitting comprises a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, such that the exposed barrier layer at the cut end of the pipe is environmentally sealed on each side by a fusion joint.

Preferably the tubular body comprises an inner fusible plastics layer and an outer plastics layer with the at least one barrier layer disposed between the inner fusible plastics layer and the outer plastics layer.

The inner plastics layer and the outer plastics layer of the composite plastics pipe can comprise any suitable thermoplastic polymeric materials, consistent with the maintenance of the required properties. Thus the inner layer is required to be compatible with the fluid flowing through the pipe and substantially impervious thereto. Suitable polymeric materials include, for example, olefinically-unsaturated polymers and co-polymers, for example, polyolefins such as polyethylene, polypropylene, polybutene and polybutylene; ethylene and propylene co-polymers, for example, ethylene-vinyl acetate polymers, and propylene-vinyl acetate polymers; halogenated-vinyl polymers such as vinyl chloride polymers and co-polymers; polyamides, for example, nylon 6, nylon 11 and nylon 66; polycarbonates; ABS polymers and ionomer polymers such as Surlyn®. Block co-polymers and blends of any of the above polymers can also be used. The polymeric materials of the inner and outer layers can also be cross-linked as required. Suitable cross-linked polymeric materials include, for example, cross-linked polyolefins, for example, cross-linked polyethylene (PEX) and oriented cross-linked polyethylene (PEXO). For many applications polyethylene is the preferred material for the inner and outer plastics layers of the pipe. The grade of polyethylene chosen, that is to say, high density, medium density, low density, or linear low density, will depend upon the particular application.

The barrier layer of the pipe is preferably a metallic layer, although pipes with barrier layers formed from plastics or other materials are not excluded. The barrier layer can comprise, for example, aluminium, aluminium alloys, stainless steel, copper, copper alloys, or any other suitable metal or metal alloy. The metal can comprise a welded sheet, for example, a welded aluminium sheet. In other embodiments the metal layer can be sputtered, or electro-deposited, or can comprise a wound and/or corrugated metal sheet. Usually the barrier layer will be bonded to the inner and outer plastics layers of the pipe through adhesive layers disposed on each side of the barrier layer.

The inner fusible layer and the outer layer of the body of the electrofusion fitting of the present invention can comprise any suitable thermoplastic polymeric materials, consistent with the maintenance of the required properties. Thus the inner layer is required to be fusible and to be able to form a fusion joint with the plastics layers of the composite pipe. Suitable polymeric materials include, for example, olefinically-unsaturated polymers and co-polymers, for example, polyolefins such as polyethylene, polypropylene, polybutene and polybutylene; ethylene and propylene co-polymers, for example, ethylene-vinyl acetate polymers, and propylene-vinyl acetate polymers; halogenated-vinyl polymers such as vinyl chloride polymers and co-polymers; polyamides, for example, nylon 6, nylon 11 and nylon 66; polycarbonates; ABS polymers and ionomer polymers such as Surlyn®. Block co-polymers and blends of any of the above polymers can also be used. The polymeric material of the outer layer can also be cross-linked as required. Suitable cross-linked polymeric materials include, for example, cross-linked polyolefins, for example, cross-linked polyethylene (PEX) and oriented cross-linked polyethylene (PEXO). For many applications polyethylene is the preferred material for the inner fusible layer of the body. The grade of polyethylene chosen, that is to say, high density, medium density, low density, or linear low density, will depend upon the particular application.

In order to be able to receive the cut end of the composite pipe, and to be fused to the inner and outer plastics layers thereof, the internal diameter of the tubular body preferably increases from its centre to one or each end of the fitting in an axial direction. For example, in one embodiment the first and second sections can be of different diameters, with the first section having a smaller diameter than the second section, separated by a step or abutment. In another embodiment the internal diameter of the tubular body can increase in a continuous fashion from its centre to one or each end of the fitting.

The first and second sections of the tubular body are each provided with a discrete electric heating element. By “discrete” electrical heating elements in this specification is meant that the electrical heating elements are spaced apart so that when energised they are separated by a relatively cold or unheated region. The electric heating elements can be resistance elements or can be heated by induction, for example, as described in WO80/02124. The heating elements can comprise, for example, an electrical conductor element, for example, a metal coil, ring, serpentine ring, expanded mesh, or other suitably shaped member, which is preferably located adjacent to, or embedded in a section of the tubular body. Preferably the electric heating elements comprise helically wound resistance wires. The heating elements may be connected in series or in parallel. The electrical conductor element may be energised, for example, by passage of an electric current there through, or by inductive heating, to form a fusion bond between the section of the tubular body and the adjacent layer of the composite pipe.

The plurality of electric heating elements are spaced apart such that the electric heating elements do not come into contact with the exposed edge of the barrier layer at the cut end of the composite pipe. The exposed edge of the barrier layer is accordingly located in a relatively cold region between the electric heating elements. For example, where the tubular body is provided with a step or abutment, the cut end of the composite pipe including the exposed edge of the barrier layer can be located against the step or abutment, which spaces apart the heating elements of the first and second sections of the tubular body. The step or abutment is not heated directly and thus there is no danger of the electric heating elements contacting the exposed edge of the barrier layer. Where the tubular body increases continuously in internal diameter from the centre to the outside in an axial direction, the heating elements are spaced apart leaving a relatively cold region between them to accommodate the exposed edge of the barrier layer. For additional protection against the possibility of the electric heating element shorting out against the exposed edge of the barrier layer it would be possible to cover the exposed edge of the barrier layer with a protective insulating film or coating, or an insulating filler material.

In one preferred embodiment of the invention, the tubular body of the electrofusion fitting is manufactured from an extruded pipe. The first and second sections of the tubular body can, for example, be produced by machining the internal bore of an extruded pipe. The heating elements can be introduced by “wire ploughing”, or any other suitable technique. In the wire ploughing technique, a helical groove is disposed in or on a fusion wall of an electrofusion fitting, from an outer part to an inner part thereof, and an electrical heating wire is located within the groove and connected at each end to an input/output terminal. Methods of wire ploughing are described in U.S. Pat. No. 4,622,087 and EP0730118 and a suitable cutting tool is described in U.S. Pat. No. 4,643,057. The entire disclosures of these prior patents are incorporated herein by reference for all purposes. In regions adjacent the barrier layer(s) the wire is preferably wholly surrounded by or embedded in the fusible inner layer of the body of the fitting. In another preferred embodiment the wire is coated with an insulating varnish or similar coating, which can also assist in preventing shorting out between adjacent turns of wire.

In another preferred embodiment of the invention the electrofusion fitting is manufactured by injection moulding the tubular body over a mould core upon which an electrical heating wire has been helical wound to provide the discrete heating elements.

The tubular body of the electrofusion fitting is preferably also provided with a barrier layer, which can be the same or different from the barrier layer of the composite pipe. The barrier layer is preferably a metallic layer and can also be a strengthening layer, producing a substantially more rigid fitting. The barrier layer can comprise, for example, aluminium, stainless steel, copper, or any other suitable metal or metal alloy. The metal can comprise a welded sheet, for example, a welded aluminium sheet. In other embodiments the metal layer can be sputtered, or electro-deposited, or can comprise a wound and/or corrugated metal sheet. Preferably the barrier layer is directly bonded to the inner and outer layers of the tubular body, although it will often be necessary for the barrier layer to be bonded to the inner and outer layers of the tubular body through adhesive layers.

In embodiments where the tubular body of the electrofusion fitting is manufactured from an extruded composite pipe the exposed edge of the barrier layer at the cut ends of the pipe will need to be protected, for example, by means of annular aluminium foil protective layers.

The electrofusion fitting of the present invention can, for example, be an in-line coupler, for connecting two composite pipes in line, a bend, for connecting two composite pipes at an angle, a transition coupler, for connecting composite pipes of different diameters, or a fitting with other connecting means, for example, a screw-threaded end, a butt fusion end, a flanged end, or similar connecting means. Where the fitting comprises a bend, this can be made by first bending a composite plastics pipe and then wire ploughing the heating elements therein.

The invention may find application in the electrofusion joining and connecting of a wide range of composite pipes. It is especially suitable for the connection of polyolefin composite pipes, and particularly polyethylene (PE and PE-X) composite pipes. Such pipes, when provided with aluminium or other metallic barrier layers normally require the presence of adhesive layers in order to bond the inner and outer polyolefin layers to the barrier layer. Hitherto it has proved very difficult to seal the exposed edges of the adhesive layers at the cut end of a composite pipe by electrofusion techniques. The present invention provides the opportunity for the exposed adhesive layers and barrier layer to be completely sealed against ingress of moisture and contaminants by electrofusion, without the need for mechanical sealing means.

### BRIEF DESCRIPTION OF THE DRAWINGS

Embodiments of electrofusion fittings and joints in accordance with the invention will now be described, by way of example only, with reference to the accompanying drawings, in which:

FIG. 1 shows a fragmentary section through one end of a first embodiment of an electrofusion coupler and joint according to the invention;

FIG. 2 shows a fragmentary section through a second embodiment of an electrofusion coupler and joint according to the invention; and

FIG. 3 shows a fragmentary section through one end of a third embodiment of an electrofusion coupler and joint according to the invention for joining PE-X composite pipe.

### DETAILED DESCRIPTION

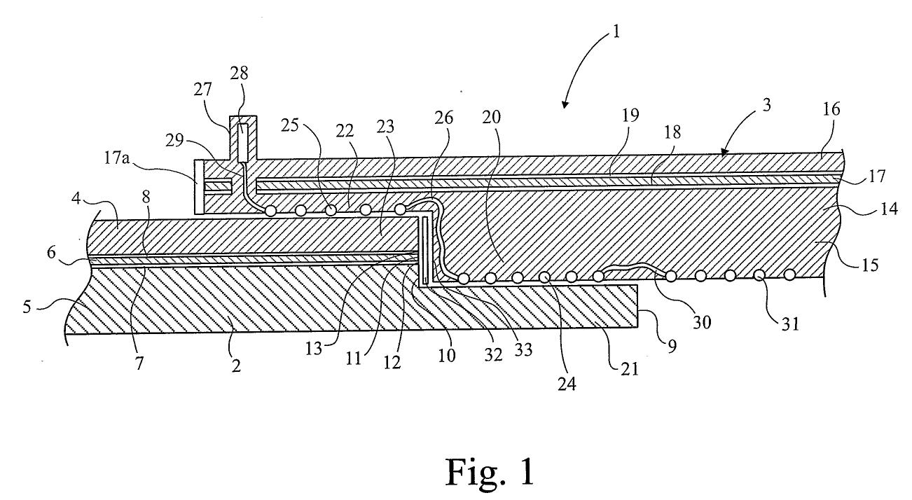

Referring firstly to FIG. 1, there is shown an electrofusion joint, illustrated generally at 1, comprising a composite pipe 2 and an electrofusion in-line coupler illustrated generally at 3. The composite pipe comprises an outer plastics layer 4, an inner plastics layer 5 and an aluminium barrier layer 6. The aluminium barrier layer 6 is bonded to the inner and outer plastics layers by adhesive layers 7 and 8 respectively. A portion of the cut end 9 of the pipe is cut back in order to provide a step or abutment 10, which includes the exposed edges 11, 12 and 13 of the aluminium barrier layer 6, and the adhesive layers 7 and 8 respectively.

The electrofusion coupler 3 comprises a body 14 comprising an inner fusible plastics layer 15, an outer plastics layer 16 and an aluminium barrier layer 17. The aluminium barrier layer is bonded to the inner and outer plastics layers of the body 14 by adhesive layers 18 and 19 respectively. The body 14 of the electrofusion coupler has a first section 20 lying adjacent to a length 21 of the inner plastics layer 5 of the pipe and a second section 22 of larger diameter lying adjacent to a cut back length 23 of the outer layer 4 of the pipe. The first and second sections 20, 22 of the body 14 are provided with embedded electric heating elements 24 and 25 respectively. The elements 24 and 25 may be of the same or different electrical design. For example, where the diameters of the first and second sections 20, 22 differ considerably the elements 24, 25 may have different wire diameters or the wire coils may have a different pitch. The elements 24 and 25 are connected by a wire 26. An upstanding electrical connector 27 is provided on the outer surface of the electrofusion coupler 3 and has a terminal 28 connected by a wire 29 to the heating element 25. The electrofusion coupler 3 is symmetrical in shape and has a similar terminal and electrical heating elements at its opposed end (not shown), which are connected in series with the terminal 28, and elements 24 and 25 (as indicated by wire 30 and fragmentary electrical heating element 31), and adapted to connect with another composite pipe end (not shown).

An optional annular insulating layer 32 can be disposed against the abutment 10 in order to provide further protection for the exposed edges 11, 12 and 13 of the aluminium and adhesive layers of the pipe 2.

The electrofusion coupler 3 is manufactured from an extruded composite pipe by machining the inner surface of the pipe to form an abutment 33, complementary to the step 10, and then wire ploughing the electric heating elements 24, 25 into the inner surface. The electrical connector is then mounted on the body 14, and the terminal 27 connected to the electric heating element 25, in a separate operation. In order to protect the cut edges of the aluminium barrier layer 17 from the environment an optional annular metallic layer 17a may be adhesively bonded to the end face of the body 14.

In forming the electrofusion joint, the composite pipe end is first cut back to produce the step or abutment 10 and then inserted into the coupler 3 until the surfaces of abutments 10 and 33 meet. A similarly prepared pipe (not shown) is inserted in the opposed end of the coupler. An electric current is then passed via the terminal 27 through the electric heating elements 24, 25 in order to fuse together the adjacent surfaces of the pipe and the coupler. Since there is little or no heating in the region of the abutments 10 and 33 these surfaces are not fused and there is no opportunity for the plastics material to flow away from the abutting surfaces. However, because the abutting surfaces are wholly surrounded by the fused regions 20, 21 and 22, 23, the exposed edges 11, 12, 13 of the aluminium barrier layer and the adhesive layers are environmentally sealed.

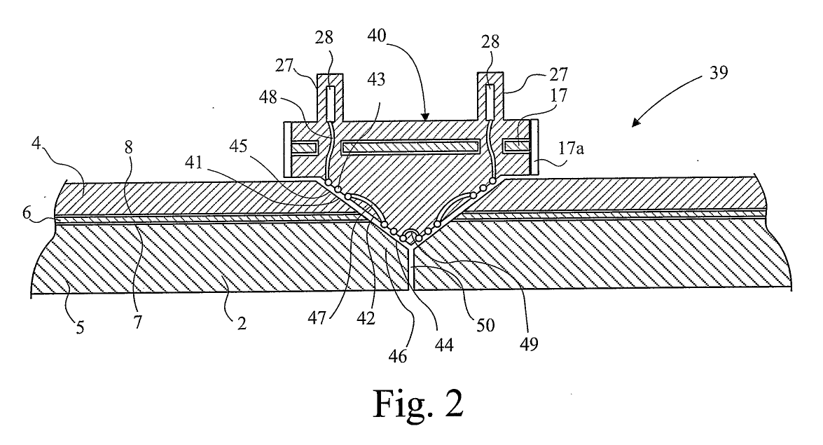

Referring now to FIG. 2, there is shown another embodiment of an electrofusion coupler and joint according to the invention wherein the same numerals refer to the same features as in FIG. 1. The joint is illustrated generally at 39 and the coupler 40 and has the same general configuration as the coupler 3 of FIG. 1. However in this case the abutting step regions 10 and 33 of the pipe and coupler of FIG. 1 are replaced by abutting sloping regions 41 and 42 respectively. Embedded in the sloping region 42 are electric heating elements 43 and 44, which are disposed adjacent lengths 45 and 46 of the inner layer 5 and the outer layer 4 of the pipe 2 respectively. The coupler is symmetrical and similar sloping regions and electric heating elements are provided at its opposed side (the right hand side in FIG. 2). The heating elements 43 and 44 are connected to each other by a bridging wire 47, heating element 43 is connected to the terminal 28 by a wire 48, and heating element 44 is connected to its adjacent heating element by bridging wire 49. The purpose of bridging wire 47 is to leave a cold zone between the heating elements 43 and 44 adjacent to the exposed edges of the aluminium barrier layer 6 and the adhesive layers 7, 8 at the cut back end of the pipe. Bridging wire 49 similarly leaves a cold zone at the junction 50 between the two pipes, to prevent molten plastics material from flowing into the interior of the pipe and leaving an exposed region of the joint for ingress of contaminants.

The coupler 40 can be manufactured by machining an extruded composite pipe in a similar manner to that described above in connection with coupler 3, although in this case a slope rather than a step is machined. The electric heating elements 43, 44 can be wire ploughed into the sloping region 42 as before.

In use the terminals 28 are connected to a source of electric power and the heating elements, which are all connected in series, cause local fusion of the surfaces of the pipe and the coupler, effectively sealing the exposed edges of the aluminium barrier layer 6 and the adhesive layers 7, 8 by fused zones and forming a strong joint. By leaving cold zones adjacent to the exposed edges of the aluminium barrier layer 6 and the adhesive layers 7, 8 and the junction 50 between the pipes, flow of plastics material away from these critical regions is avoided.

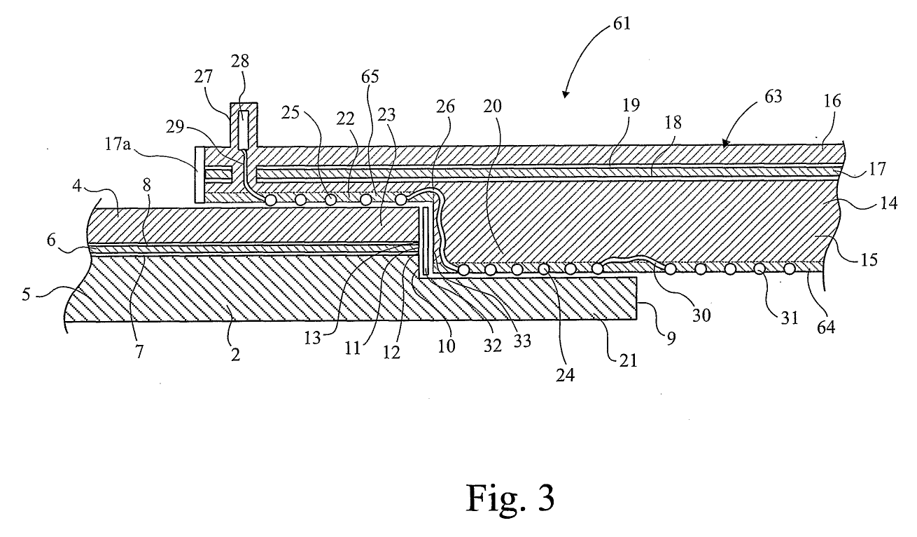

Referring now to FIG. 3, there is shown a further embodiment of an electrofusion coupler and joint according to the invention wherein the same numerals refer to the same features as in FIG. 1. The joint, which is for PE-X composite pipe, is illustrated generally at 61, and comprises a composite PE-X pipe 62 and an electrofusion in-line coupler illustrated generally at 63. The coupler is similar in design to the coupler of FIG. 1, except that the body 14 is formed from cross-linked polyethylene (PE-X), and there are provided fusible thermoplastic layers 64 and 65 respectively on the first and second sections 20 and 22 of the body. When the heating elements 24 and 25 are energised, the fusible thermoplastic layers 64 and 65 melt and fuse to the PE-X layers 21 and 23 of the PE-X pipe forming a fusion joint as in FIG. 1.

Whilst the couplers illustrated in FIGS. 1 to 3 are symmetrical, this need not always be the case, and it is envisaged within the invention that unsymmetrical couplers, having electrofusion elements at one end and a mechanical connection at the other, or combining different types of electrofusion connections, for example in reducer couplings, are also possible.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. An electrofusion fitting for a composite plastics pipe, the pipe comprising at least one inner plastics layer, at least one outer plastics layer and at least one barrier layer therebetween, the fitting comprising a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, such that the exposed barrier layer at the cut end of the pipe is environmentally sealed on each side by a fusion joint.

2. An electrofusion fitting according to claim 1, wherein the tubular body comprises an inner fusible plastics layer and an outer plastics layer with the at least one barrier layer disposed between the inner fusible plastics layer and the outer plastics layer.

3. An electrofusion fitting according to claim 1, wherein the inner fusible layer and the outer layer of the body of the electrofusion fitting comprise a polyolefin polymer material.

4. An electrofusion fitting according to claim 1, wherein the internal diameter of the tubular body increases from the centre to one or each end of the fitting in an axial direction.

5. An electrofusion fitting according to claim 4, wherein the first and second sections are of different diameters, with the first section having a smaller diameter than the second section, the sections being separated by a step or abutment.

6. An electrofusion fitting according to claim 4, wherein the internal diameter of the tubular body increases in a continuous fashion from the centre to the or each end of the fitting.

7. An electrofusion fitting according to claim 1, wherein the electric heating elements comprise a metal coil, ring, serpentine ring, or expanded mesh.

8. An electrofusion fitting according to claim 1, wherein the electric heating elements are embedded in a section of the tubular body.

9. An electrofusion fitting according to claim 1, wherein the electric heating elements comprise helically wound resistance wires.

10. An electrofusion fitting according to claim 1, wherein the electric heating elements are connected in series.

11. An electrofusion fitting according to claim 1, wherein the electric heating elements are of the same electrical design.

12. An electrofusion fitting according to claim 1, wherein the electric heating elements are of different electrical design.

13. An electrofusion fitting according to claim 5, wherein the cut end of the composite pipe including the exposed edge of the barrier layer is located against the step or abutment that spaces apart the heating elements of the first and second sections of the tubular body.

14. An electrofusion fitting according to claim 6, wherein the heating elements are spaced apart leaving a relatively cold region between them to accommodate the exposed edge of the barrier layer.

15. An electrofusion fitting according to claim 1, wherein a protective film or coating or an insulating filler material is provided to cover the exposed edge of the barrier layer of the composite pipe.

16. An electrofusion fitting according to claim 1, wherein the tubular body of the electrofusion fitting is manufactured from an extruded pipe.

17. An electrofusion fitting according to claim 16, wherein the heating elements are introduced by wire ploughing.

18. An electrofusion fitting according to claim 1, wherein the tubular body of the electrofusion fitting is provided with a barrier layer.

19. An electrofusion fitting according to claim 18, wherein the barrier layer is metallic.

20. An electrofusion fitting according to claim 19, wherein the barrier layer comprises aluminium, aluminium alloy, stainless steel, copper or copper alloy.

21. An electrofusion fitting according to claim 16, wherein the tubular body of the electrofusion fitting is manufactured from a composite extruded pipe and the exposed edge of the barrier layer at the cut ends of the composite pipe is protected by means of an annular protective layer.

22. An electrofusion fitting according to claim 1, which is an in-line coupler, for connecting two composite pipes in line, a bend, for connecting two composite pipes at an angle, a transition coupler, for connecting composite pipes of different diameters, or a fitting with other connecting means.

23. (canceled)

24. (canceled)

25. A method of forming a joint for a composite pipe, the pipe comprising at least one inner plastics layer, at least one outer plastics layer and at least one barrier layer therebetween, wherein there is used an electrofusion fitting, the fitting comprising a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cut-back length of the outer plastics layer, each of the first and second sections being provided with a discrete heating element adapted, when energized, to make a fusion joint between the section and its adjacent pipe layer, inserting the cut pipe end into the tubular body and energizing the electric heating elements to fuse the first and second sections respectively to the inner and outer plastics layers such that the exposed barrier layer at the cut end of the pipe is environmentally sealed on each side by a fusion joint.

26. (canceled)

27. (canceled)

28. A joint for a composite pipe formed using an electrofusion fitting according to claim 25.

29. Use of an electrofusion fitting to form a joint in a composite pipe, the pipe comprising at least one inner plastics layer, at least one outer plastics layer and at least one barrier layer therebetween, wherein the fitting comprises a tubular body formed at least in part from a thermoplastic polymer material and comprising at least one barrier layer and adapted to receive a cut end of the pipe, and a plurality of electric heating elements disposed within the body, the body having a first section adapted to receive a length of the inner plastics layer and a second section adapted to receive a cutback length of the outer plastics layer, each of the first and second sections being provided with a discrete heating element adapted, when energized, to make a fusion joint between the section and its adjacent pipe layer, such that the exposed barrier layer at the cut end of the pipe is environmentally sealed on each side by a fusion joint.

30. (canceled)
